(19) United States
(12) Patent Application Publication
(10) Pub. No.: US 2011/0151289 A1
(43) Pub. Date: Jun. 23, 2011

(54) ENERGY STORAGE DEVICE AND ASSOCIATED METHOD

(75) Inventors: Michael Alan Vallance, Loudonville, NY (US); Hari Nadathur Seshadri, Bangalore (IN); Guruprasad Sundararajan, Bangalore (IN); David Charles Bogdan, JR., Scotia, NY (US); Karthick Vilapakkam Gourishankar, Bangalore (IN)

(73) Assignee: GENERAL ELECTRIC COMPANY, SCHENECTADY, NY (US)

(21) Appl. No.: 12/641,737

(22) Filed: Dec. 18, 2009

(51) Int. Cl. H01M 10/36

(52) U.S. Cl. 429/50; 429/320; 429/321

(57) ABSTRACT

An energy storage device is provided. The energy storage device includes a cathode material and a separator in electrical communication with the cathode material. The cathode material includes zinc. The separator has a first surface that defines at least a portion of a first chamber, and a second surface that defines a second chamber. The first chamber is in ionic communication with the second chamber through the separator. The separator includes an alkali-metal-ion conducting material and a toughening material. A method for operating the energy storage device is also provided. Furthermore, an energy storage system including the energy storage device is provided.

### BACKGROUND

The invention relates generally to an ion-conducting solid electrolyte separator for an energy storage device. More particularly, the invention relates to an alkali-metal-ion conducting solid electrolyte separator for a sodium metal halide battery. The invention also relates to a method for operating such an energy storage device.

Batteries are essential components used to store a portion of the energy in mobile systems such as electric vehicles, and hybrid electric vehicles and non-vehicles (for example locomotives, off-highway mining vehicles, marine applications, buses and automobiles). Batteries are also essential for stationary applications, such as uninterruptible power supply (UPS) systems and “Telecom” (telecommunication) systems. In the case of vehicles, the energy is often regenerated during braking, for later use during motoring. In general, energy can be generated when the demand is low, for later use, thus reducing fuel consumption. In general, battery operating environments are harsh for several reasons, including, but not being limited to, large changes in environmental operating temperatures, extended mechanical vibrations, and the existence of corrosive contaminants.

Many different types of batteries are known to exist. However, current high-temperature batteries, such as, for example, sodium metal halide batteries, have superior performance, and are the most promising type of batteries for electric vehicles. Sodium is used as a negative electrode in a battery cell. An ion-conducting solid electrolyte separates the sodium anode from a positive electrode (cathode). A second, molten electrolyte transports sodium ions to and from the solid electrolyte separator on the cathode side. The melting point of the molten electrolyte, along with the temperature-dependent sodium-ion conductivity of the solid electrolyte, determines the minimum operating temperature of the battery. The cathode should include a material that is soluble in the molten electrolyte, and is compatible with the solid electrolyte in the charged (oxidized) state.

As understood by those of ordinary skill, successful operation of the metal halide battery cell depends upon the proper functioning of the solid electrolyte separator. One of the factors that may limit cell life is failure of the solid electrolyte. Such failures involve initiation and propagation of a crack from the surface of the solid electrolyte, insufficient strength and fracture toughness of the material, and perforation of the molten electrolyte. Usually, perforation of the molten electrolyte is caused by surface ablation, due to deposition of the cathode material on the surface of the solid electrolyte.

It would therefore be desirable to develop a sodium metal halide cell having an improved solid electrolyte separator, and characterized by high reliability and extended lifetime.

### BRIEF DESCRIPTION

According to some embodiments of the present invention, an energy storage device is provided. The energy storage device includes a cathode material and a separator in electrical communication with the cathode material. The cathode material includes zinc. The separator has a first surface that defines at least a portion of a first chamber, and a second surface that defines a second chamber. The first chamber is in ionic communication with the second chamber through the separator. The separator includes an alkali-metal-ion conducting material and a toughening material. An energy storage system including the energy storage device is also provided.

Some embodiments of the present invention provide a method for operating an energy storage device. The method includes the step of transporting alkali-metal-ions between a first chamber and a second chamber through a separator. The separator is in electrical communication with a cathode material that includes zinc. The separator includes an alkali-metal-ion conducting material and a toughening material. The method further includes the step of blocking infiltration of the cathode material into interstitial spaces of the separator during alkali-metal-ion transportation.

### DRAWINGS

These and other features, aspects, and advantages of the present invention will become better understood when the following detailed description is read with reference to the accompanying drawing, wherein:

FIG. 1 is a schematic of an embodiment of the present invention.

FIG. 2 is a scanning electron micrograph of a solid electrolyte separator.

FIG. 3 is a scanning electron micrograph of a solid electrolyte separator, according to one embodiment of the invention.

FIG. 4 is a scanning electron micrograph of a solid electrolyte separator, according to one embodiment of the invention.

### DETAILED DESCRIPTION

As discussed in detail below, some of the embodiments of the present invention provide an alkali-metal-ion conducting solid electrolyte separator for a metal halide battery cell. These embodiments advantageously avoid the risk of damaging the separator caused by deposition of cathode materials within the solid electrolyte separator microstructure.

Approximating language, as used herein throughout the specification and claims, may be applied to modify any quantitative representation that could permissibly vary, without resulting in a change in the basic function to which it is related. Accordingly, a value modified by a term or terms, such as “about”, is not limited to the precise value specified. In some instances, the approximating language may correspond to the precision of an instrument for measuring the value.

In the following specification and claims, the singular forms “a”, “an” and “the” include plural referents, unless the context clearly dictates otherwise.

As used herein, “cathode material” is the material that supplies electrons during charging, and is present as part of a redox reaction. The “anode material” accepts electrons during charging, and is present as part of the redox reaction.

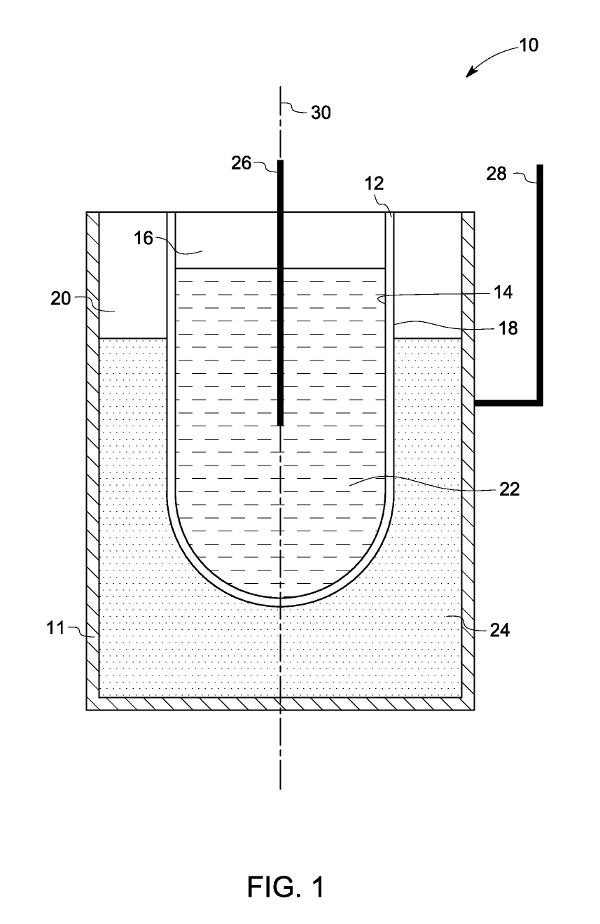

FIG. 1 illustrates an energy storage device 10 (also referred to as an electrochemical cell) according to one embodiment of the invention. The electrochemical cell 10 includes a separator 12 having a first surface 14 that defines at least a portion of a first chamber 16, and a second surface 18 that defines a second chamber 20. The first chamber 16 is in ionic communication with the second chamber 20 through the separator 12. The separator 12 is an alkali-metal-ion conductor electrolyte. The first chamber 16 includes a cathode material 22, and the second chamber 20 includes an anode material 24. The first chamber 16 and the second chamber 20 further include current collectors 26 and 28, to collect the current produced by the electrochemical cell.

The second chamber 20 is, generally, a container, and has a casing 11. The casing 11 can be sized and shaped to have a cross-sectional profile that is square, polygonal, or circular. Suitable materials for the casing may be a metal, a ceramic or a composite. The metal may be selected from the group consisting of nickel, mild steel, stainless steel, nickel-coated steel, molybdenum and molybdenum-coated steel, as examples. The ceramic may be a metal oxide.

The separator 12 is disposed within the second chamber 20. With regard to the separator 12, the first chamber 16 is disposed within the second chamber 20, and is elongated to define an axis 30. Thus, in a typical embodiment, the first chamber 16 is coaxially disposed about the axis 30. With further reference to the separator 12, it may be a tubular container in one embodiment, and can have a cross-sectional profile normal to the axis 30 that is a circle, a triangle, a square, a cross, or a star. Alternatively, the separator can be substantially planar. A planar configuration (or a configuration with a slight dome) may be useful in a prismatic or button-type battery configuration. Suitable materials for the separator are described below.

An alkali-metal-ion is transported across the separator 12 between the first chamber 16 and the second chamber 20 in one embodiment. In one embodiment, the second chamber 20 contains the alkali metal that may function as the anode material 24, and the second chamber may function as an anode. Suitable ionic materials may include one or more of sodium, lithium and potassium. In one embodiment, the anode material is sodium. The second chamber may receive and store a reservoir of the anode material. The anode material is usually molten during use. Additives suitable for use in the anode material may include a metal oxygen scavenger. Suitable metal oxygen scavengers may include one or more of manganese, vanadium, zirconium, aluminum, or titanium. Other useful additives may include materials that increase wetting of the separator surface by the molten anode material. Additionally, some additives may enhance the contact or wetting of the separator with regard to the current collector, to ensure substantially uniform current flow throughout the separator.

In one embodiment, the first chamber may contain a cathode material and may function as a cathode. The cathode material may exist in elemental form or as a salt, depending on a state of charge (i.e., in regard to the ratio of the forms of material which are present). The cathode material may contain an alkali metal, and the salt form of the cathode material may be a halide. According to some embodiments of the invention, the cathode material includes zinc. Other suitable materials for use as the cathode material may include aluminum, nickel, copper, chromium, cobalt, tin, arsenic, tungsten, molybdenum, iron, and various combinations thereof. The halide of the alkali metal may be chlorine, fluorine, bromine, iodine, or various combinations thereof.

In one embodiment, at least two cathode materials may be used, i.e., a first cathode material and a second cathode material. The first cathode material includes zinc in some embodiments of the invention. The second cathode material is different from the first cathode material, and may also be selected from aluminum, nickel, copper, chromium, cobalt and iron. In one embodiment, the second cathode material includes copper. Other suitable second cathode materials are tin, arsenic, tungsten, titanium, niobium, molybdenum, tantalum, vanadium, and various combinations thereof. In one embodiment, the first cathode material may be present relative to the second cathode material by a ratio varying from about 1:10 to about 1:1. In some specific embodiments, the first cathode material is present relative to the second cathode material by a ratio that is in a range from about 1:5 to about 1:2.

The cathode material can be self-supporting or liquid/molten. In one embodiment, the cathode material is disposed on a support structure. The support structure can be in a number of forms, such as a foam, a mesh, a weave, a felt, or a plurality of packed particles, fibers, or whiskers. In one embodiment, a suitable support structure may be formed from brass. The function and advantage of such an electrochemical cell having brass as the support structure for the cathode material containing zinc is described in a patent application (application Ser. No. 12/330,752) “Energy Storage Device and System” filed on Dec. 9, 2008 for C. Iacovangelo et al, which is incorporated herein by reference.

The cathode material can be secured to an outer surface of the support structure. In some instances, the support structure can have a high surface area. The cathode material on the support structure may be adjacent to the first surface of the separator, and extend away from that separator surface. The support structure can extend away from the first surface to a thickness that is greater than about 0.01 millimeter. In one embodiment, the thickness is in a range of from about 0.01 millimeter to about 20 millimeters, and in other embodiments, from about 1 millimeter to about 20 millimeters. For larger capacity electrochemical cells, the thickness may be larger than 20 millimeters.

A sulfur or a phosphorous-containing additive may be disposed in the cathode material. For example, elemental sulfur, sodium sulfide or zinc sulfide may be disposed in the cathode. The presence of these additives in the cathode may reduce or prevent recrystallization of salts, and grain growth.

In one embodiment, the first chamber further includes a molten electrolyte along with the cathode material. The molten electrolyte allows rapid transport of alkali metal ions from the cathode material to the separator, and in the reverse direction. Thus, use of the molten electrolyte provides high power and high efficiency in the electrochemical cell operation.

Suitable molten electrolytes may include a binary electrolyte or a ternary electrolyte. In a ternary electrolyte, alkali metal halide and zinc halide are usually present in a determined amount relative to aluminum halide. The amount of the zinc halide present in the ternary electrolyte may be greater than about 20 mole percent relative to the amount of the aluminum halide.

In addition to the alkali metal halide and the zinc halide, the balance of the ternary electrolyte is usually aluminum halide. With regard to the halide portion, each of the halides of the ternary electrolyte may have a common halide, such as chloride. Alternately, the common halide may include bromide, iodide or fluoride. In one embodiment, the halide may include chloride and one or more additional halides. If a second or additional halide is present, then relative to the common halide, the amount of additional halide may be greater than about 0.1 mole percent of the total halide concentration. In one embodiment, the additional halide amount is in range of from about 0.1 mole percent to about 10 mole percent, and more specifically, from about 1 mole percent to about 5 mole percent.

The molten electrolyte has a nominal average melting point of about 150 degree Celsius. A suitable operating temperature for the electrochemical cell having the molten electrolyte may be greater than about 350 degrees Celsius. At lower operating temperatures, e.g., below about 350 degrees Celsius, the cell (ternary electrolyte) may have relatively higher resistance. The molten electrolyte may have an ionic resistivity that is greater than about 1.0 ohm-centimeter. In one embodiment, the molten electrolyte may have an ionic resistivity in a range of from about 1.0 ohm-centimeter to about 2.5 ohms-centimeter. In a preferred embodiment, the ionic resistivity of the molten electrolyte is in a range from about 1.5 ohms-centimeter to about 2.0 ohms-centimeter.

The electrochemical cell 10 is typically assembled in the discharged state. Applying a voltage between the anode 20 and the cathode 16 of the electrochemical cell charges the cell 10. In one embodiment, sodium chloride in the cathode dissolves to form sodium ions and chloride ions during charging. Sodium ions, under the influence of an applied electrical potential, conduct through the separator and combine with electrons from the external circuit to form the sodium electrode. Chloride ions react with the cathode material to form metal chloride, and donate electrons back to the external circuit. During discharge, sodium ions conduct back through the separator, reversing the reaction, and generating electrons. The cell reaction is as follows:

nNaCl+M [symbol] MCln+nNa++ne−

As discussed above, the separator 12 is usually an alkali-metal-ion conductor solid electrolyte that conducts alkali metal ions during use. Suitable materials for the solid electrolyte include alkali-metal-beta′-alumina, alkali-metal-beta″-alumina, alkali-metal-beta′-gallate, or alkali-metal-beta″-gallate. Beta alumina has a composition range defined by an Na₂O—Al₂O₃ phase diagram. The beta alumina has a hexagonal crystal structure, and contains about 1 mole of Na₂O to about 9 moles of Al₂O₃. The beta″ (double prime) alumina has a higher ratio of about 1 mole of Na₂O to about 5 moles of Al₂O₃, and has rhombohedral structure. In one embodiment, the separator includes a beta″ alumina. In this instance, the separator is also referred as beta″ alumina separator electrolyte (BASE). Sodium ion conductivity of one form of beta″ alumina separator electrolyte at 300 degrees Celsius is in a range of from about 0.2 ohm⁻¹ cm⁻¹ to about 0.4 ohm⁻¹ cm⁻¹. In one embodiment, a portion of the separator comprises alpha alumina, and another portion of the separator comprises beta″ alumina. The alpha alumina may be relatively more amenable to bonding (e.g., compression bonding) than beta alumina, and may help with sealing and/or fabrication of the cell.

The separator is characterized by an ionic conductivity. The ionic resistance of the separator (i.e., across its thickness) may depend in part on the thickness itself. A suitable thickness can be less than about 5 millimeters. In one embodiment, the thickness of the separator is in a range of from about 0.5 millimeter to about 5 millimeters. In a preferred embodiment, the thickness of the separator is in a range of from about 1 millimeter to about 2 millimeters.

According to some embodiments of the invention, the separator 12 further includes a toughening material. In other words, the separator may be a composite of the alkali-metal-ion conducting solid electrolyte material and the toughening material. The “toughening material”, as used herein, refers to an additive material to the alkali-metal-ion conducting solid electrolyte, which has good strength and good chemical stability. The presence of the toughening material may be effective in strengthening and toughening the solid electrolyte, mechanically and chemically.

Suitable toughening materials include, but are not limited to, zirconia, yttria, hafnia, ceria and thoria. These toughening materials may be used alone or in combination with themselves or with other materials. Other materials may include alkali metal oxides, alkaline metal oxides, transition metal oxides and rare earth metal oxides. Suitable mixed oxides include yttria stabilized zirconia (YSZ), rare earth oxide doped zirconia, scandia doped zirconia, rare earth oxide doped ceria, alkaline earth oxide doped ceria, or stabilized hafnia. In a specific embodiment, the toughening material includes zirconia. In another specific embodiment, the toughening material includes yttria-stabilized zirconia (YSZ).

The amount of the toughening material is less than about 10 weight percent of the total weight of the solid electrolyte. In one embodiment, the amount of toughening material is in a range of from about 0.5 weight percent to about 10 weight percent, and more specifically, from about 1 weight percent to about 8 weight percent. In a preferred embodiment, the amount is in a range from about 2 weight percent to about 5 weight percent.

In one embodiment, the toughening material is dispersed within the solid electrolyte material. In some embodiments, the toughened separator has a microstructure having a plurality of grains. The plurality of grains may contain some grains of the toughening material (e.g., zirconia) in an interpenetrating phase or matrix, as disclosed herein. In one embodiment, grains of the toughening material are randomly distributed within the solid electrolyte.

In another embodiment, the separator has a graded concentration of the grains of the toughening material through the thickness of the separator. As used herein, the term “graded” generally refers to a concentration of the indicated material, which changes over a cross-sectional difference. Unless indicated otherwise, “graded” includes smoothly sloped rates of concentration change, as well as a plurality of step changes of concentration. In an axial direction, the concentration of the grains of toughening material may be graded. However, in at least one embodiment, the grains may extend a certain distance and then stop, as the separator has a boundary—the other side of which is alpha alumina.

In addition, the grains of the separator have grain boundaries defining interstitial spaces. Such interstitial spaces provide relatively higher conductivity of alkali-metal-ions. According to some embodiments of the invention, the interstitial spaces are substantially free of the cathode material. In a specific embodiment, the interstitial spaces are substantially free of zinc. Furthermore, in one embodiment, the interstitial spaces are substantially free of the molten electrolyte.

Typically, during operation of the cell, the cathode material, such as zinc, deposits in the interstitial spaces between the grains. According to embodiments of the present invention, the toughened separator blocks the infiltration of zinc into the interstitial spaces during use, where such infiltration is undesirable. The toughened separator is compatible with the cathode material and the molten electrolyte, and thus allows rapid transport of alkali-metal-ions. Thus, the microstructure of the toughened separator does not unduly change or degrade during use, and provides high power and high efficiency in the electrochemical cell operation.

Furthermore, the resulting toughened separator is generally stronger, more durable, and more reliable, as compared to separators known previously. Therefore, the toughened separator exhibits higher current densities for failure initiation, higher tolerance for mechanical stress, and lower requirements for separator thickness. A thinner separator may provide relatively high ionic conductivity, while maintaining suitably high strength.

As discussed above, the electrochemical cell 10 has current collectors, 26 and 28, including a cathode current collector and an anode current collector. The anode current collector 28 is in electrical communication with the casing 11 of the second chamber 20, and the cathode current collector 26 is in electrical communication with the cathode material 22, or with the first chamber 16. Suitable materials for the anode current collector may include W, Ti, Ni, Cu, Mo or combinations of two or more thereof. Carbon can also be used. The cathode current collector may be a wire, paddle or mesh, usually formed from Pt, Pd, Au, Ni, Cu, C, or Ti. The current collector may be plated or clad. The anode current collector and cathode current collector usually have a thickness greater than about 1 millimeter (mm).

The first and the second chambers 16 and 20 can be sealed to the separator 12 by a sealing structure (not shown in drawings), for example a gasket, a sealing strip or a sealing composition. The sealing structure provides separation between the contents of the cell and the environment, and also prevents leakage and contamination. Also, the sealing structure isolates the first chamber and the second chamber from the outside environment, and from each other.

The sealing structure can be a glassy composition, a cermet or a combination thereof, as examples. Suitable glassy sealing compositions may include, but are not limited to phosphates, silicates, borates, germanates, vanadates, zirconates, and arsenates. These materials can be employed in various forms, for example, borosilicates, aluminosilicate, calcium silicate, binary alkali silicates, alkali borates, or a combination of two or more thereof. The cermet may contain alumina and a refractory metal. Suitable refractory metals may include one or more of molybdenum, rhenium, tantalum or tungsten. Alternatively, the end portions of the separator may include alpha alumina. The alpha alumina can be bonded directly to the lid that encloses the second chamber. Suitable bonding methods may include thermal compression bonding, diffusion bonding, or thin film metallizing. Each of these methods may be used in conjunction with welding or brazing techniques.

The sealing structure is capable of remaining intact at elevated temperatures. Each chamber 16 and 20 is usually sealed at a temperature greater than about 300 degrees Celsius. In one embodiment, the operating temperature range for the cell is from about 300 degrees Celsius to about 500 degrees Celsius. In some preferred embodiments, the operating temperature of the cell is in a range from about 400 degrees Celsius to about 475 degrees Celsius. In certain embodiments, the operating temperature of the cell is as high as about 500 degrees Celsius. The separator does not substantially etch or pit in the presence of a halogen, or in the presence of the anode material.

A plurality of the electrochemical cells can be organized into an energy storage system, in one embodiment. Multiple cells can be connected in series or parallel. For convenience, a group of coupled cells may be referred to as a module or pack. The ratings for the power and energy of the module depend on such factors as the number of cells in the module. Other factors may be based on end-use application specific criteria.

Various embodiments of the energy storage system can store an amount of energy greater than about 10 kilowatt-Hours. In some embodiments, the energy storage system may store energy less than about 10 kilowatt-Hours depending on the requirement. One embodiment of the energy storage system has an energy-by-weight ratio greater than about 100 Watt-Hours/kilogram, and/or an energy-by-volume ratio of greater than about 160 Watt-Hours/liter. Another embodiment of the energy storage device has a specific power rating of greater than about 150 Watts/kilogram. A suitable energy storage system may have an application specific power-to-energy ratio in a range of from about 1 hour⁻¹ to about 10 hour⁻¹.

In one embodiment of the energy storage system, a controller (not shown) communicates with the plurality of the cells. The controller can distribute an electrical load to select cells in a cell module, in response to feedback signals indicating states for each of the cells in the cell module. The controller can perform a re-warm method in which a series of heating elements are activated in a sequence to melt a frozen portion of the energy storage system in a determined manner. In another embodiment, the controller may distribute an electrical load to select cathode materials at determined locations within individual cells. Suitable controllers, which perform such functions, are available in the art.

If present, a heat management device maintains the temperature of the energy storage system. The heat management device can warm the energy storage system if too cold, and can cool the energy storage system if too warm. The heat management system includes a thaw profile that can maintain a minimal heat level in the first and second chambers, to avoid freezing of the cell reagents.

Another embodiment of the invention provides an energy management system that includes a second energy storage device that differs from the first energy storage device. This dual energy storage device system can address the ratio of power-to-energy, such that a first energy storage device can be optimized for efficient energy storage, and a second energy storage device can be optimized for power delivery. The control system can draw charge from either energy storage device as needed, and can also provide a charge to either energy storage device, when necessary.

Suitable second energy storage devices for the power section include a primary battery, a secondary battery, a fuel cell, or an ultracapacitor. A suitable secondary battery may be a lithium battery, lithium ion battery, lithium polymer battery, or a nickel metal hydride battery.

### EXAMPLES

The example that follows is merely illustrative, and should not be construed to be any sort of limitation on the scope of the claimed invention.

Three electrochemical cells were constructed. Comparative example 1 and examples 2 and 3 had substantially similar components, except for the solid electrolyte separators. The separator tubes, cylindrical in shape, were commercially obtained from two different suppliers. Each tube was ceramic sodium conductive beta″ alumina (BASE). The separator tubes from the first supplier—Beta Research & Development, Ltd.—were cloverleaf in shape, with equivalent cylinder dimensions of 228 mm length, 36 mm internal diameter, and 38 mm outer diameter. The tube was filled with supporting electrolyte, and contained cathode material. The ceramic separator tube was glass-sealed to an alpha alumina collar to form an assembly. The assembly was placed in a stainless steel casing filled with molten sodium. The casing served as the housing for an electrochemical cell. The casing size was about 38 mm×38 mm×230 mm. The separator tubes from the second supplier—Ionotec, Ltd.—were cylindrical in shape, with dimensions of 80 mm length, 20 mm internal diameter, and 24 mm outer diameter. Each tube was placed in a molten sodium pool anode, which was contained in an outer alpha-alumina crucible. Each tube was filled with supporting electrolyte, and contained cathode material, and was closed with a ceramic cap.

The cathode material included 25 weight % zinc powder and 30 weight % alpha-brass powder. The cathode material is disposed in the volume of the housing, and within the separator tube, and functions as the working cathode. The brass functions as a current collector and is in electrical communication with leads, allowing current flow. The housing functions as a second current collector.

### Comparative Example 1

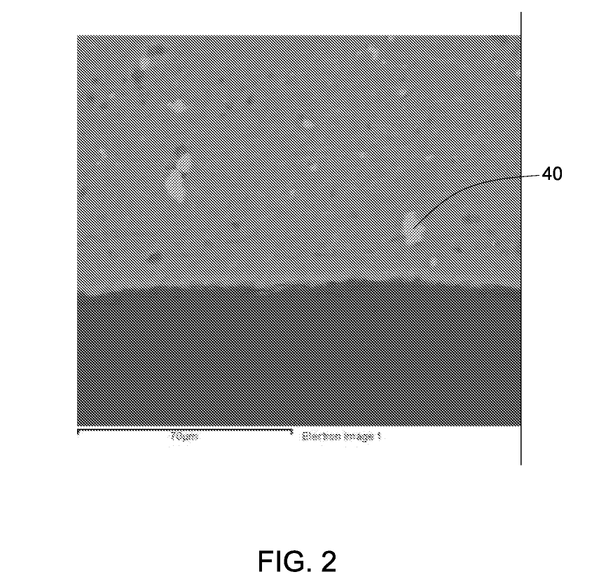

The first cell employed the separator tube from BETA Research & Development Ltd. The cell was operated for a number of charge/discharge cycles. The separator was post-tested near the cathode interface for cathode material infiltration. FIG. 2 shows scanning electron micrographs of a cross-section of the cell, near the cathode-separator interface. SEM-EDS analysis was conducted at region or “spot” 40 of FIG. 2. (SEM-EDS is the name of the energy-dispersive X-ray spectroscopy analysis conducted by means of SEM. This technique allows one to determine the chemical composition of a specimen, as well as its morphology and structure). The result of SEM-EDS analysis of spot 40 is shown in Table 1 below, which shows the presence of zinc. Thus, it is clear that zinc penetrates into the BASE separator during operation. Also, it is found that zinc penetration was up to about 150 microns into the BASE separator.

### Example 1

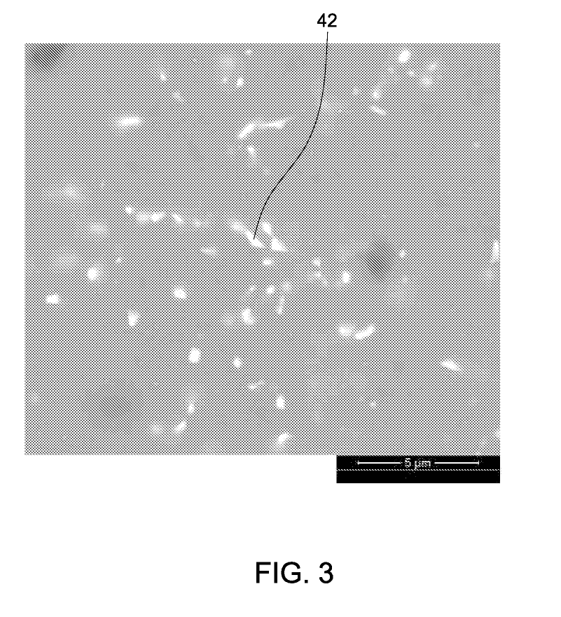

The second electrochemical cell employed the separator tube (BASE) from Ionotec Ltd. The cell was operated for a number of charge/discharge cycles. The BASE from Ionotec Ltd. comprised zirconium oxide, as a toughening agent. The toughened BASE separator was post-tested near the cathode interface, for evidence of cathode material infiltration. FIG. 3 is a scanning electron micrographs (SEM) of a cross-section of the cell near the cathode-separator interface. The bright spots show zirconium oxide inclusions. SEM-EDS analysis was conducted at spot 42 of FIG. 3. The result of SEM-EDS analysis of spot 42 is given in Table 1 below, showing no evidence of the presence of zinc or copper.

### Example 2

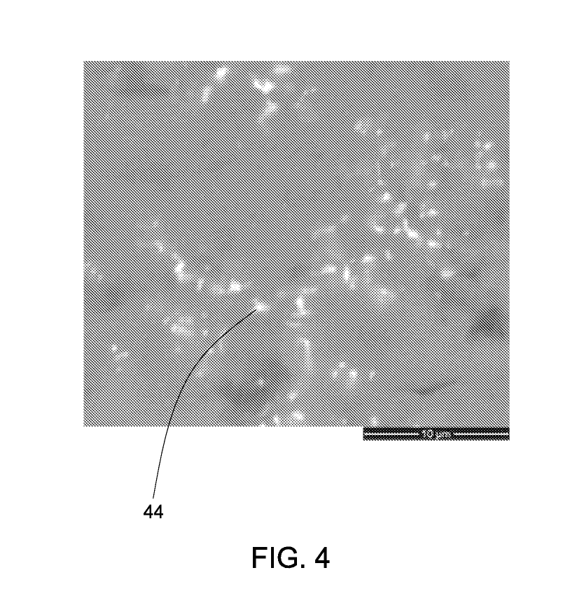

The third electrochemical cell employed the separator tube (BASE) from Ionotec Ltd. The cathode of this cell further included 7.3 weight % of iron. The cell was operated for a number of charge/discharge cycles. The BASE from Ionotec Ltd. comprised zirconium oxide as a toughening agent. The toughened BASE separator was post-tested near the cathode interface for cathode material infiltration. FIG. 4 is a scanning electron micrograph (SEM) of a cross-section of the cell near the cathode-separator interface. The bright spots show zirconium oxide inclusions. SEM-EDS analysis was conducted at spot 44 of FIG. 4. The result of the SEM-EDS analysis of spot 44 is given in Table 1 below, showing no evidence of the presence of zinc, iron, or copper.

Thus, it is clear that cathode materials did not penetrate into the toughened BASE separator during operation.

TABLE 1

| Example | Element | Weight % | Atomic % |
|---|---|---|---|
| Comparative example 1 | O | 3.59 | 12.76 |
| | Al | 2.76 | 5.81 |
| | Zn | 93.65 | 81.43 |
| Example 1 | O | 29.47 | 46.33 |
| | Na | 3.48 | 3.81 |
| | Al | 47.78 | 44.54 |
| | Cu | 0 | 0 |
| | Zn | 0 | 0 |
| | Zr | 19.26 | 5.31 |
| Example 2 | O | 44.49 | 60.79 |
| | Na | 3.79 | 3.6 |
| | Al | 40.66 | 32.95 |
| | Fe | 0 | 0 |
| | Cu | 0 | 0 |
| | Zn | 0 | 0 |
| | Zr | 11.06 | 2.65 |

While only certain features of the invention have been illustrated and described herein, many modifications and changes will occur to those skilled in the art. It is, therefore, to be understood that the appended claims are intended to cover all such modifications and changes as fall within the true spirit of the invention.

1. An energy storage device, comprising:
a cathode material comprising zinc; and
a separator in electrical communication with the cathode material, wherein the separator has a first surface that defines at least a portion of a first chamber, and a second surface that defines a second chamber, and the first chamber is in ionic communication with the second chamber through the separator,
wherein the separator comprises an alkali-metal-ion conducting material and a toughening material.

2. The energy storage device of claim 1, wherein the first chamber is electronically isolatable from the second chamber.

3. The energy storage device of claim 1, wherein the second chamber is disposed within the first chamber.

4. The energy storage device of claim 1, wherein the second chamber is elongate, and defines an axis.

5. The energy storage device of claim 4, wherein the first chamber is coaxially disposed about the axis.

6. The energy storage device of claim 1, wherein the separator is substantially planar.

7. The energy storage device of claim 1, wherein the separator has a cross-sectional profile normal to the axis, in the shape of a circle, a triangle, a square, a cross, or a star.

8. The energy storage device of claim 1, wherein the separator is an alkali-metal-ion conductor and comprises at least one of alkali-metal-beta-alumina, alkali-metal-beta″ (double prime)-alumina, alkali-metal-beta-gallate, or alkali-metal-beta″ (double prime)-gallate.

9. The energy storage device of claim 1, wherein the separator comprises one or more toughening materials selected from the group consisting of zirconia, yttria, hafnia, ceria, and thoria.

10. The energy storage device of claim 9, wherein the toughening material is present in an amount varying from about 0.5 weight percent to about 10 weight percent.

11. The energy storage device of claim 1, wherein the separator comprises zirconia or stabilized zirconia.

12. The energy storage device of claim 1, wherein the separator comprises a plurality of grains, and the grains define grain boundaries.

13. The energy storage device of claim 12, wherein the grain boundaries define interstitial spaces.

14. The energy storage device of claim 13, wherein the interstitial spaces are substantially free of zinc or of a cathode material.

15. The energy storage device of claim 1, further comprising an anode material disposed in the second chamber.

16. The energy storage device of claim 15, wherein the anode material comprises one or more metals selected from the group consisting of sodium, lithium, potassium, and calcium.

17. The energy storage device of claim 1, wherein the cathode material further comprises one or more metals selected from the group consisting of nickel, aluminum, copper, chromium, cobalt and iron.

18. The energy storage device of claim 1, wherein the first chamber further comprises a support structure comprising brass.

19. The energy storage device of claim 1, wherein the cathode material further comprises one or more halides selected from the group consisting of chlorine, fluorine, bromine, and iodine.

20. The energy storage device of claim 1, wherein the first chamber further comprises a molten electrolyte.

21. An energy storage system comprising the energy storage device of claim 1.

22. The energy storage system of claim 21, characterized as having an energy storage capacity greater than about 10 kilowatt-Hours.

23. The energy storage system of claim 21, having an energy-by-weight ratio of greater than 100 Watt-Hours/kilogram, and an energy-by-volume ratio of greater than 160 Watt-Hours per liter.

24. The energy storage system of claim 21, having a power-to-energy ratio in a range of from about 1 (hour⁻¹) to about 10 (hour⁻¹).

25. A method for operating an energy storage device, comprising the steps of:
transporting alkali-metal-ions between a first chamber and a second chamber through a separator, that is in electrical communication with a cathode material that comprises zinc, and
blocking infiltration of zinc or the cathode material into interstitial spaces of the separator during alkali-metal-ion transportation,
wherein the separator comprises an alkali-metal-ion conducting material and a toughening material.
